(19) United States
(12) Patent Application Publication
(10) Pub. No.: US 2010/0198482 A1
(43) Pub. Date: Aug. 5, 2010

(54) Method and device for operating an internal combustion engine having cylinder shutdown

(76) Inventors: Dirk Hartmann, Stuttgart (DE); George Mallebrein, Korntal-Muenchingen (DE); Werner Mezger, Eberstadt (DE); Andreas Roth, Muehlacker-Lomersheim (DE); Henri Barbier, Schwieberdingen (DE); Nikolas Poertner, Stuttgart (DE); Jürgen Rappold, Ilsfeld-Auenstein (DE); Ingo Fecht, Ludwigsburg (DE)

Correspondence Address: KENYON & KENYON LLP, ONE BROADWAY, NEW YORK, NY, 10004, US

(21) Appl. No.: 11/989,842

(22) PCT Filed: Jul. 20, 2006
(86) PCT No.: PCT/EP2006/064433

§ 371 Date: Apr. 12, 2010

(30) Foreign Application Priority Data
Aug. 3, 2005 (DE) 102005036440.3

(51) Int. Cl. F02D 41/04; F02D 17/02

(52) U.S. Cl. 701/103; 123/198 F

(57) ABSTRACT

A method and a device for operating internal combustion engine, in particular in an unfired state, are described, which make possible a largely jerk-free switchover between two operating states of internal combustion engine, having different numbers of cylinders that are activated regarding the charge cycle. Air is supplied to the internal combustion engine via an actuator in an air supply, and the quantity of air supplied to the internal combustion engine is influenced by the position of the actuator. A charge cycle state of at least one cylinder of the internal combustion engine is changed. The position of the actuator in the air supply is changed with the change of the charge cycle state of the at least one cylinder.

### FIELD OF THE INVENTION

The present invention is directed to a method and a device for operating an internal combustion engine, in particular in an unfired state.

### BACKGROUND INFORMATION

It is understood that air may be supplied to the internal combustion engine in an air supply via an actuator designed as a throttle valve, for example, the quantity of air supplied to the internal combustion engine being influenced by the position of the throttle valve. It is also understood that the charge cycle state of at least one cylinder of the internal combustion engine may be changed during the unfired state of the internal combustion engine, which is achieved, for example, by overrun shutoff, by closing its intake and exhaust valves for a longer period, so that no charge cycle occurs via this cylinder anymore. The charge cycle may be interrupted in one-half of the cylinders.

### SUMMARY OF THE INVENTION

The method according to the present invention and the device according to the present invention for operating an internal combustion engine, in particular in an unfired state, having the features of the independent claims, have the advantage over the related art that with the change in the charge cycle state of the at least one cylinder the position of the actuator in the air supply is changed. This permits, when the position of the actuator is appropriately changed, changing the charge cycle state of the at least one cylinder using reduced pressure and therefore more comfortably. A change in the charge cycle state of at least one cylinder of the internal combustion engine is thus less perceptible by the driver in the case of a vehicle being propelled by the internal combustion engine.

The measures recited in the subclaims make advantageous improvements on and refinements of the method described in the main claim possible.

The above-described change in the charge cycle state of at least one cylinder of the internal combustion engine may be made more comfortable in an easier way in the case where the previously activated charge cycle of the at least one cylinder is interrupted if the position of the actuator in the air supply is changed to reduce the air quantity supplied to the internal combustion engine.

The change in the charge cycle state of at least one cylinder of the internal combustion engine may be made more comfortable in an easier way in particular in the case where a previously interrupted charge cycle of the at least one cylinder is activated if the position of the actuator in the air supply is changed to increase the air quantity supplied to the internal combustion engine.

A definite improvement in comfort results if the position of the actuator in the air supply is changed by a predefined value.

Maximum comfort and minimum jerk during the change of the charge cycle state of at least one cylinder of the internal combustion engine result when the predefined value is ascertained in such a way that the clutch torque remains constant after the change in the charge cycle state of the at least one cylinder and the simultaneous change in the position of the actuator.

The predefined value may be ascertained simply by calibration or modeling.

It is also advantageous if the charge cycle state is changed in one-half of the cylinders, in particular in every other cylinder of the ignition sequence. This permits a change in the charge cycle state to be implemented in a particularly simple manner by switching off or interrupting the charge cycle, for example, for a complete cylinder bank of the internal combustion engine in the case where the internal combustion engine has two such cylinder banks. In general, for an even number of cylinder banks, one-half of the cylinder banks may be completely shut off regarding the charge cycle of their cylinders.

By changing or interrupting the charge cycle in every other cylinder of the ignition sequence, a smoother run of the engine is also ensured.

The charge cycle over the at least one cylinder may be interrupted in a particularly simple manner by deactivating its valve gear on the intake and/or exhaust side or may be activated by activating its valve gear on the intake and/or exhaust side.

An exemplary embodiment of the present invention is depicted in the drawing and elucidated in greater detail in the description that follows.

### BRIEF DESCRIPTION OF THE DRAWINGS

FIG. 1 shows a block diagram of an internal combustion engine having two cylinder banks.

FIG. 2 shows a function diagram for changing the charge cycle state of at least one cylinder of the internal combustion engine as a function of a request.

FIG. 3 shows a function diagram for elucidating the method according to the present invention and the device according to the present invention for changing the position of an actuator in an air supply of the internal combustion engine as a function of the change of the charge cycle state of the at least one cylinder.

FIG. 4a through FIG. 4i show the variation over time of different performance quantities of the internal combustion engine before and after the change of the charge cycle state of at least one cylinder of the internal combustion engine.

### DETAILED DESCRIPTION

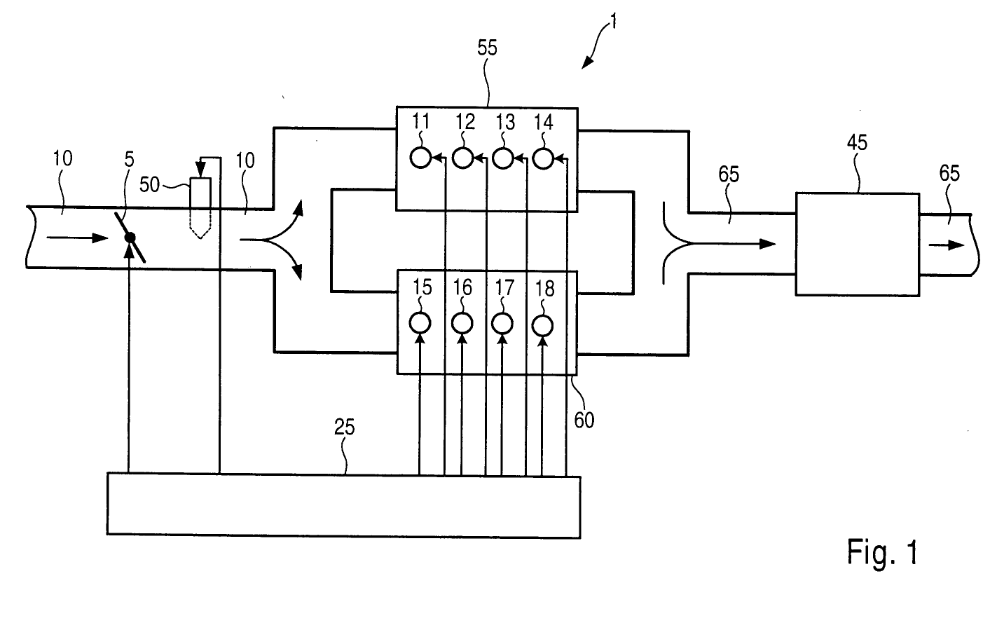

In FIG. 1, reference numeral 1 identifies an internal combustion engine, which propels a vehicle, for example. Internal combustion engine 1 may be designed as a gasoline engine or a diesel engine, for example. In this example, internal combustion engine 1 includes an even number n of cylinder banks; in the example of FIG. 1, n is equal to 2. Alternatively, the exemplary embodiments and/or exemplary method of the present invention may also be implemented using an odd number of cylinder banks, or even a single cylinder bank, for example. Each cylinder bank in the present example includes the same number of cylinders. Internal combustion engine 1 according to the example of FIG. 1 thus includes a cylinder bank 55 having a first cylinder 11, a second cylinder 12, a third cylinder 13, and a fourth cylinder 14. Furthermore, internal combustion engine 1 according to FIG. 1 includes a second cylinder bank 60 having a fifth cylinder 15, a sixth cylinder 16, a seventh cylinder 17, and an eighth cylinder 18. Fresh air is supplied to cylinders 11, . . . , 18 of both cylinder banks 55, 60 via an air supply 10. An actuator 5 is situated in air supply 10 for influencing the air quantity supplied to cylinders 11, . . . , 18. This air quantity varies as a function of the setting or position or opening angle or degree of opening of actuator 5. In the following it will be assumed, for example, that actuator 5 is designed as a throttle valve.

The flow direction of the air in air supply 10 is indicated by arrows in FIG. 1. The position of the throttle valve, i.e., its opening angle, is controlled by a controller 25 as known to those skilled in the art, for example, as a function of the operation of an accelerator pedal not depicted in FIG. 1, or as a function of the request by a vehicle system not depicted in FIG. 1 such as an antilock system, a traction control system, an electronic stability program, a cruise control system, or the like. Downstream from throttle valve 5, fuel is injected into air supply 10 via an injector 50, injector 50 and thus fuel metering also being controlled by controller 25 as known to those skilled in the art, for example, for setting a predefined air/fuel mixture ratio. Alternatively, fuel may also be injected into air supply 10 upstream from throttle valve 5 or directly into the combustion chambers of cylinders 11, . . . , 18.

Furthermore, according to FIG. 1, the valve gear of cylinders 11, . . . , 18 and thus their intake and exhaust valves are controlled by engine controller 25 as known to those skilled in the art, via a fully variable valve control. Alternatively, this valve gear may also be set using camshafts as known to those skilled in the art. The exhaust gas formed in the combustion chambers of cylinders 11, . . . , 18 by the combustion of the air/fuel mixture is expelled via the exhaust valves of cylinders 11, . . . , 18 into an exhaust gas system 65. The flow direction of the exhaust gas in exhaust system 65 is also indicated in FIG. 1 by arrows. An exhaust gas treatment system 45 in the form of a catalytic converter, for example, is situated in exhaust gas system 65 for preventing, via conversion, the emission of undesirable pollutants as much as possible.

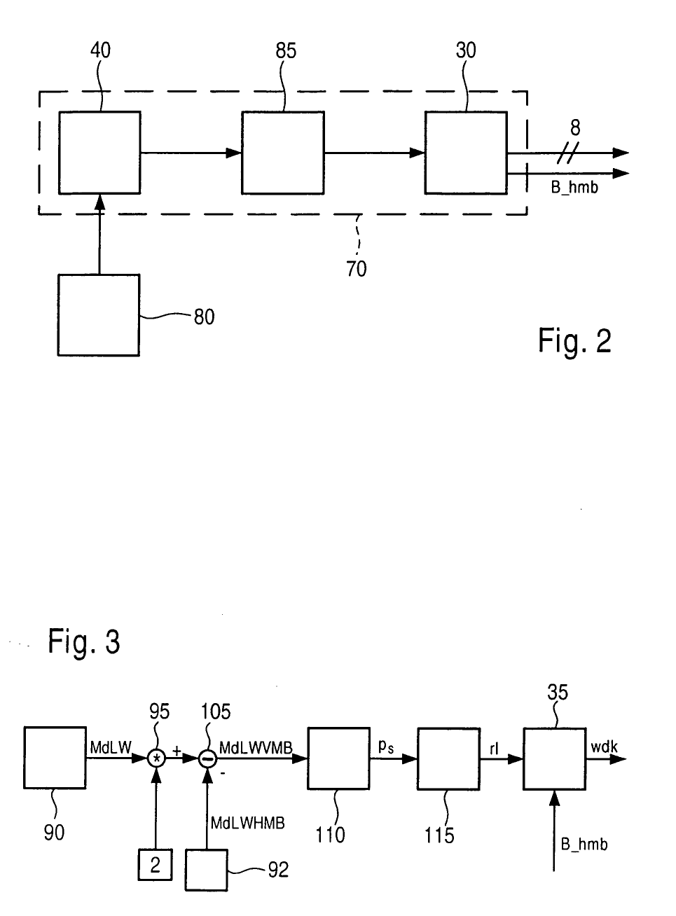

FIG. 2 shows a function diagram labeled with reference numeral 70, with whose help the charge cycle state of at least one of cylinders 11, 12, . . . , 18 of the internal combustion engine is changed as a function of a received request. Function diagram 70 may be implemented as software and/or hardware, for example, in engine controller 25. Function diagram 70 includes a receiver unit 40 for receiving a request from a request generating unit 80 situated outside function diagram 70. Such a request may be a request for changing the temperature gradient of exhaust gas treatment device 45, for example. Such a request may be generated by engine controller 25, for example.

For this purpose, engine controller 25 compares, for example, an actual temperature of catalytic converter 45 with a setpoint temperature of catalytic converter 45, and from this difference deduces a request for changing the temperature gradient of catalytic converter 45 over time. For example, when the actual temperature of the catalytic converter is less than the setpoint temperature by more than a predefined value, engine controller 25 may request an increase in the temperature gradient. Conversely, when the actual temperature of the catalytic converter exceeds the setpoint temperature by more than a predefined value, engine controller 25 may request a decrease in the temperature gradient of catalytic converter 45.

The request for change of the temperature gradient is predefined by request generating unit 80, which may also be implemented in engine controller 25 as software and/or hardware. Another example of a request is a deceleration request for decelerating the vehicle propelled by internal combustion engine 1. Such a deceleration request is received by controller 25, for example, due to the operation of a brake pedal by the driver or as a deceleration request of a vehicle system such as, for example, an antilock system, a traction control system, an electronic stability program, or the like. In this case, request generating unit 80 represents the corresponding vehicle system or the brake pedal module.

Receiver unit 40 receives the above-described request from request generating unit 80 and relays it to a converter unit 85 in the function diagram. Converter unit 85 converts the received request into a request to change the charge cycle state of cylinders 11, 12, . . . , 18 and relays this request to arrangement 30 for changing the charge cycle state of cylinders 11, 12, . . . , 18. Arrangement 30 includes an actuator system, which sets the valve gear of the intake and/or exhaust valves of each cylinder 11, 12, . . . , 18 according to the request delivered by converter unit 85. The intake and/or exhaust valves of each cylinder 11, 12, . . . , 18 may be set, i.e., opened or closed, individually by arrangement 30. Each cylinder 11, . . . , 18 includes one or more intake valves and one or more exhaust valves. With the aid of arrangement 30, all intake valves and/or all exhaust valves of each cylinder 11, 12, . . . , 18 may be closed for a longer period, so that the charge cycle over the corresponding cylinder is interrupted, i.e., deactivated for that period. Since each cylinder 11, . . . , 18 may be controlled individually as described above, FIG. 2 shows eight outputs of arrangement 30.

A change of the charge cycle state of at least one of cylinders 11, . . . , 18 thus results from the charge cycle over the at least one cylinder 11, . . . , 18 being interrupted starting from an activated state by closing all of its intake valves and/or all of its exhaust valves for a longer period. Conversely, the charge cycle state of the at least one cylinder 11, . . . , 18 may be changed by reactivating the charge cycle over the at least one cylinder 11, . . . , 18 starting from a deactivated state by opening and closing the intake valves and/or the exhaust valves of the at least one cylinder 11, . . . , 18 for performing the charge cycle alternatingly in a conventional manner according to the cylinder cycle.

In an advantageous specific embodiment, a distinction is made between two operating states of internal combustion engine 1 regarding the charge cycle state of cylinders 11, . . . , 18. In a first operating state, the charge cycle is interrupted over one-half of cylinders 11, . . . , 18 by closing their intake and/or exhaust valves for a longer period. The charge cycle over all cylinders of one of the two cylinder banks 55, 60a may be interrupted, while the charge cycle over all cylinders of the other two cylinder banks 55, 60 is activated.

Alternatively, also one-half of the cylinders of first cylinder bank 55 and one-half of the cylinders of second cylinder bank 60 or in general one-half of the cylinders regardless of which cylinder bank they are in may be deactivated regarding the charge cycle, while the charge cycle over the other cylinders is activated. In general, and also in the case of an odd number of cylinder banks, only part, for example, one-half of all cylinders of internal combustion engine 1 is deactivated regarding the charge cycle, and the other part of all cylinders of internal combustion engine 1 is activated regarding the charge cycle. If, for example, the ignition sequence of cylinders 11, . . . , 18 is as follows:

First cylinder 11, fifth cylinder 16, second cylinder 12, sixth cylinder 16, third cylinder 13, seventh cylinder 17, fourth cylinder 14, eighth cylinder 18.

It may also be provided that every other cylinder of the ignition sequence is excluded from the charge cycle regardless of which cylinder bank it is located in, and the charge cycle is activated over the other cylinders. In the above-described example, in the case where all cylinders 11, 12, 13, 14 of first cylinder bank 55 are excluded from the charge cycle and the charge cycle over all other cylinders 15, 16, 17, 18, of second cylinder bank 60 is activated, it would result, for example, in every other cylinder in the ignition sequence being excluded from the charge cycle, while the other cylinders in the ignition sequence would have a charge cycle. In this way, the quietest possible engine operation results despite the charge cycle being interrupted in one-half of the cylinders.

In a second operating state, all cylinders 11, . . . , 18 should be activated regarding the charge cycle.

The charge cycle state of cylinders 11, . . . , 18 is now changed by simply switching over between the first operating state and the second operating state. The first operating state is referred to as half-engine operation and the second operating state as full-engine operation. This switchover between the two operating states may occur in both fired and unfired operation of internal combustion engine 1. In unfired operation, fuel injection via injector 50 is suppressed for a longer period, in contrast to fired operation, during which fuel is regularly injected. Fired operation of internal combustion engine 1 means, for example, a “pull” operation, and an unfired operation exists, for example, in an overrun operation of internal combustion engine 1. Unfired overrun operation of internal combustion engine 1 is also known as overrun shutoff, i.e., the corresponding injectors of all cylinders are closed.

In the following, it is assumed as an example that switchover between the first operating state and the second operating state occurs in unfired operation of internal combustion engine 1, i.e., during overrun shutoff, for example.

It is now provided to change the position of throttle valve 5 when the charge cycle state of the at least one cylinder 11, . . . , 18 is changed; as described above, in this exemplary embodiment the change of the charge cycle state of the at least one cylinder 11, . . . , 18 is represented by switching between the first operating state and the second operating state. The objective of this measure is to avoid, as much as possible, a jerk of internal combustion engine 1, i.e., of the vehicle propelled by it, when switching between the first operating state and the second operating state, thus making the operation of the internal combustion engine more comfortable. For this purpose, it is provided that the position of throttle valve 5 is changed to reduce the air quantity supplied to internal combustion engine 1 when a previously activated charge cycle over at least one cylinder 11, . . . , 18 is interrupted. This means that, when switching from the second operating state to the first operating state, the throttle valve is operated in the direction of closing.

Similarly, when a previously interrupted charge cycle over at least one cylinder 11, . . . , 18 is activated, the position of throttle valve 5 is changed to increase the air quantity supplied to internal combustion engine 1. This means that, when switching from the first operating state to the second operating state, throttle valve 5 is operated in the direction of opening.

It has been found advantageous to change the position of throttle valve 5 by a predefined value. The predefined value is ascertained in such a way that, after the change of the charge cycle state of the at least one cylinder 11, 12, . . . , 18, and the change in the position of throttle valve 5 occurring simultaneously with the change in the charge cycle state, the clutch torque of internal combustion engine 1 remains constant compared to the charge cycle state of the at least one cylinder 11, . . . 18 prior to the change in the charge cycle state. In this way, in the ideal case, the jerk of internal combustion engine 1, i.e., the vehicle, is fully avoided when the charge cycle state of the at least one cylinder 11, . . . , 18 is changed. The predefined value for the change in the position of throttle valve 5 may be ascertained via calibration, for example, on a test bench, as a function of the instantaneous operating state of internal combustion engine 1, in particular as a function of the engine speed and engine load of internal combustion engine 1. As an alternative, the predefined value may be ascertained via modeling. An example of such a modeling of the predefined value for changing the position of throttle valve 5 is elucidated with reference to function diagram 75 in FIG. 3.

A torque loss appears at the output of internal combustion engine 1 due to engine friction and charge cycle losses. The torque loss is therefore equal to the sum of the friction torque and the charge cycle torque loss. The instantaneous charge cycle torque loss value is ascertained in a first torque ascertaining unit 90 of second function diagram 75 as known to those skilled in the art. Ideally, the instantaneous charge cycle torque loss value in the first operating state must be equal to that in the second operating state. Since the charge cycle torque loss value in the first operating state is only one-half of that in the second operating state, the instantaneous charge cycle torque loss value must be multiplied by the factor two in a multiplication element 95. The charge cycle torque loss value obtained for the cylinder in which the charge cycle is suppressed is subtracted from the product formed in this way in a subtraction element 105 of function diagram 75. This value is ascertained in a second torque ascertaining unit 92 and is equal to zero in the first operating state of internal combustion engine 1 because in the cylinders in which the charge cycle is suppressed also no charge cycle losses or charge cycle torque losses may occur. The difference at the output of subtraction element 105 is therefore equal to the charge cycle torque loss value of those cylinders whose charge cycle is activated. This charge cycle torque loss value of the cylinders having activated charge cycles is supplied, for example, to an inverse integral function

$${( {\int }_{pV}^{ps} p * d V )}^{- 1}$$

of the pV diagram of internal combustion engine 1 as the input value, where pₛ is the intake manifold pressure downstream from throttle valve 5 and pᵤ is the ambient pressure. Intake manifold pressure pₛ associated with the charge cycle torque loss value of the cylinders having activated charge cycles is then obtained at the output of the inverse integral function.

Ambient pressure pᵤ may be ascertained as known to those skilled in the art, for example, with the help of a pressure sensor not depicted in FIG. 1. Instead of the inverse integral function, a characteristics map or a characteristics curve, calibrated on a test bench, for example, may also be used. The inverse integral function is labeled in FIG. 3 with reference numeral 110. Intake manifold pressure pₛ at the output of inverse integral function 110 is supplied to a characteristics curve 115, which converts intake manifold pressure pₛ into the associated value for cylinder charge rl. In the simplest case, instead of characteristics curve 115, a multiplication element may be used, which multiplies intake manifold pressure pₛ by a conversion factor fupsrl to obtain the value for charge rl. The conversion factor or characteristics curve 115 may also be calibrated on a test bench, for example, as a function of the operating state of internal combustion engine 1, i.e., in particular of the engine speed and engine load. Charge rl ascertained from characteristics curve 115 or via conversion is supplied to an actuator unit 35 of function diagram 75, which ascertains the opening angle of throttle valve 5, associated with charge rl. Actuator unit 35 causes the opening angle of throttle valve 5 to be set at the ascertained opening angle and thus causes a change in the opening angle of throttle valve 5 by a value predefined by the opening angle ascertained by actuator unit 35 and by an opening angle existing prior to the switchover between the first and second operating states. Actuator unit 35 actuates throttle valve 5 in the closing direction to the ascertained opening angle when a switchover from the second operating state to the first operating state has been detected.

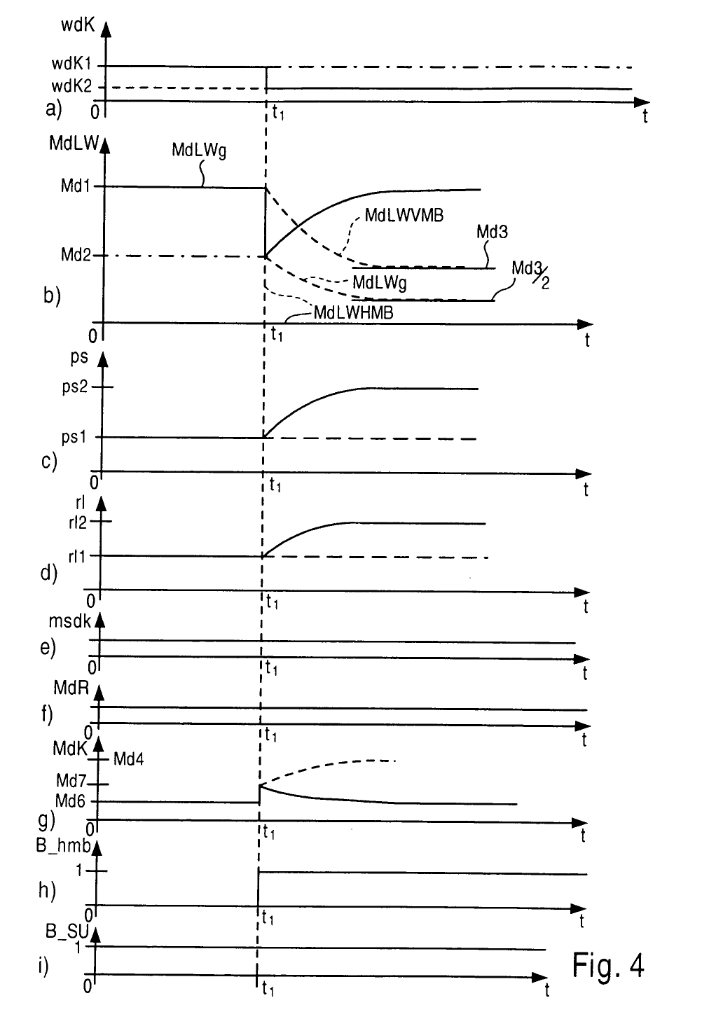

However, if a switchover from the first operating state to the second operating state has occurred, actuating unit 35 actuates throttle valve 5 in the opening direction to the ascertained opening angle. Whether a switchover from the first operating state to the second operating state or from the second operating state to the first operating state has occurred is detected by actuator unit 35 via the supply of a corresponding signal B_hmb which is shown in FIG. 4h). This signal is set in the first operating state and reset in the second operating state and is generated and output by arrangement 30 depending on the request to the charge cycle state of the cylinders. This signal is then supplied to actuating unit 35.

In the ideal case, a change in the clutch torque of internal combustion engine 1 due to the switchover between the first operating state and the second operating state is fully compensated by the change in the position of throttle valve 5 by actuating unit 35. The charge cycle torque loss value at the output of first torque ascertaining unit 90 is labeled MdLW. The output of second torque ascertaining unit 92 as charge torque loss value of the cylinders not activated for the charge cycle is labeled MdLWHMB; the output of subtraction element 105 as charge cycle torque loss value of the cylinders activated for the charge cycle is labeled MdLWVMB; the output of inverse integral function 110 is labeled intake manifold pressure pₛ, the output of characteristics curve 115 is labeled charge rl, and the value at the output of actuating unit 35 is labeled wdk.

When switchover occurs from the second operating state to the first operating state, charge cycle torque loss value MdLWHMB ascertained by second torque ascertaining unit 92 is equal to zero as described above, and thus MdLWVMB is equal to 2*MdLW. When switchover occurs from the first operating state to the second operating state, charge cycle torque loss value MdLWHMB ascertained by second torque ascertaining unit 92 is the charge cycle torque loss value of those cylinders which were previously shut off regarding the charge cycle and are now activated. Thus, MdLWHMB=0.5*MdLW=MdLWVMB.

The functioning of function diagram 75 of FIG. 3 is now elucidated with reference to the time diagrams of different performance quantities of internal combustion engine 1 according to FIGS. 4a) through 4i) using the example of the switchover from the second operating state to the first operating state.

According to FIG. 4i, a signal B_SU is permanently set over the time period in question and indicates an overrun shutoff. If the B_SU signal is reset, there is no overrun shutoff. The B_SU signal is generated by engine controller 25. Furthermore, FIG. 4h) shows the curve of the B_hmb signal which is generated, as described above, by arrangement 30. This B_hmb signal is reset up to a first point in time t₁ and is set at point in time t₁, remaining set thereafter. This means that internal combustion engine 1 is in the second operating state up to first point in time t₁, after which it is in the first operating state. At first point in time t₁ switchover thus occurs from full-engine operation to half-engine operation. According to FIG. 4a), at first point in time t₁ the degree of opening of throttle valve 5 is equal to wdk1.

Without the above-described function of second function diagram 75, the degree of opening of throttle valve 5 would assume value wdk1 also after first point in time t₁, i.e., it would remain unchanged, provided constant boundary conditions existed, in particular in the form of a constant driver's intent or constant requests from other vehicle systems such as, for example, antilock system, traction control system, electronic stability program, cruise control system, or the like. Due to the cylinders that were shut down at first point in time t₁ in half-engine operation and to the absence of charge cycles in that state, the flow in the intake manifold, which characterizes the part of air supply downstream from throttle valve 5, is reduced. Intake manifold pressure pₛ thus rises, starting at first point in time t₁, from a first value Pₛ₁ asymptotically to a second value pₛ₂ according to FIG. 4c) because the degree of opening of throttle valve 5 remains constant.

The curve of intake manifold pressure pₛ is therefore not discontinuous, but continuous, because intake manifold pressure pₛ must build up downstream from throttle valve 5 over time. The charge cycle losses are caused by the pressure ratio of intake manifold pressure pₛ to ambient pressure pᵤ according to the p-V diagram of internal combustion engine 1. The charge cycle torque loss drops with increasing intake manifold pressure pₛ. In addition, the charge cycle losses across the intake and exhaust valves of cylinders 11, . . . , 18 are reduced, because only one-half of cylinders 11, . . . , 18 are active regarding the charge cycle. The total charge cycle torque loss MdLWg up to first point in time t₁ is equal to Md1 according to FIG. 4b). The total charge cycle torque loss MdLWg up to first point in time t₁ is equal to the charge cycle torque loss of both first cylinder bank 55 and second cylinder bank 60.

The total charge cycle torque loss MdLWg is always the mean value of the charge cycle torque losses of the two cylinder banks 55, 60. At first point in time t₁ charge cycle torque loss MdLWHMB of the cylinder bank deactivated at first point in time t₁ regarding the charge cycle jumps to the value zero. Due to the increasing intake manifold pressure pₛ, starting at first point in time t₁, charge cycle torque loss MdLWVMB of the cylinder bank whose cylinders are still activated after first point in time t₁ regarding the charge cycle also drops asymptotically to a value Md3. The curve of the entire charge cycle torque loss MdLWg is thus obtained as the mean value between charge cycle torque losses MdLWHMB, MdLWVMB of the two cylinder banks as depicted in FIG. 4b). The total charge cycle torque loss MdLWg therefore jumps at first point in time t₁ to a value Md2=½Md1 and from there it drops asymptotically toward a value Md3/2, Md3 being less than Md2 in the example of FIG. 4b).

As FIG. 4d) shows, charge rl also increases with boost pressure pₛ from first point in time t₁ starting at a first value rl1, asymptotically toward a second value r12. According to FIG. 4e), air mass flow msdk through throttle valve 5 remains constant over the entire time period under consideration, provided internal combustion engine 1 is being operated above the critical operating range in which air moves in air supply 10 at the speed of sound.

According to FIG. 4f), friction torque MdR is also assumed to be constant over the entire time period. Clutch torque MdK, the difference between inner torque Mi and the total torque loss Mv of internal combustion engine 1, jumps at first point in time t₁ from a value Md6 to a value Md7>Md6 and increases from value Md7 for times t>t₁ to a value Md4 according to the dashed line in FIG. 4g). Torque loss Mv of internal combustion engine 1 is equal to the sum of friction torque MdR and the total charge cycle torque loss MdLWg. Thus, assuming a constant internal torque Mi=0 of internal combustion engine 1, the curve of clutch torque MdK is inverse to the curve of total charge cycle torque loss MdLWg.

According to FIG. 3, using function diagram 75 according to the exemplary embodiments and/or exemplary method of the present invention, charge cycle torque loss MdLWVMB is detected, in particular starting at first point in time t₁ as described above, and the associated intake manifold pressure pₛ is ascertained with the aid of the pV diagram, and therefrom charge rl and therefrom the required position of throttle valve 5, for compensating the above-mentioned changes in charge rl, intake manifold pressure pₛ, and charge cycle torque loss MdLWVMB. This position of throttle valve 5 is set at first point in time t₁ via actuating arrangement 35, which is manifested in a change from degree of opening wdk1 to degree of opening wdk2<wdk1 at first point in time t₁ according to the solid curve of degree of opening wdk in FIG. 4a). Ultimately this results in both charge rl and intake manifold pressure pₛ remaining constant after point in time t₁ compared to the time before point in time t₁ according to the dashed curve in FIG. 4d).

For the curve of total charge cycle torque loss MdLWg according to the solid line in FIG. 4b), this means that the total charge cycle torque loss MdLWg rises again asymptotically against value Md1 after jumping to value Md2=0.5*Md1 at first point in time t₁. Similarly, clutch torque MdK jumps from value Md6 to value Md7>Md6 at first point in time t₁, and subsequently goes back asymptotically toward value Md6. Using the method according to the present invention, clutch torque MdK may thus be held largely constant at value Md6 up to the above-mentioned jump in comparison with the dashed curve. This results in the driver of the motor vehicle propelled by internal combustion engine 1 perceiving the switch from the second operating state to the first operating state at first point in time t₁ minimally (due to the above-mentioned jump) or not at all.

The above-described measure according to the present invention thus almost fully compensates the intake manifold pressure increase starting at first point in time t₁. Consequently, intake manifold pressure pₛ remains approximately constant as described above. If intake manifold pressure pₛ remains approximately constant, the intake manifold pressure pₛ to ambient pressure pᵤ ratio will also remain constant. As described previously, this results in the entire charge cycle torque loss MdLWg returning asymptotically to the original value Md1 after the jump at point in time t₁, as consequently clutch torque MdK returns asymptotically to the original value Md6 after the jump at first point in time t₁.

If a switchover occurs from half-engine operation to full-engine operation, a jerk of internal combustion engine 1 due to this switch may be largely avoided, for example, by appropriately increasing the degree of opening of throttle valve 5 with the switchover to full-engine operation similarly to FIG. 4, for example, to bring back total charge cycle torque loss MdLWg and thus clutch torque MdK, after the jump caused by the switchover, asymptotically to the value that existed directly prior to the jump and thus prior to the switchover into full-engine operation. Intake manifold pressure pₛ and charge rl have a similar constant behavior when a switchover from half-engine operation to full-engine operation occurs.

The charge cycle over the at least one cylinder 11, 12, . . . , 18 is interrupted by closing its intake and/or exhaust valves for a longer period or, in other words, by deactivating its valve gear on the intake and/or exhaust side. The charge cycle over the at least one cylinder 11, 12, . . . , 18 is activated by operating the intake and/or exhaust valves of this at least one cylinder 11, 12, . . . , 18 in a conventional manner as described above or, in other words, by activating the valve gear of this at least one cylinder on the intake and/or exhaust side.

The method according to the present invention and the device according to the present invention for operating internal combustion engine 1 make it possible, in particular in an unfired state of internal combustion engine 1, to perform a largely jerk-free switchover between two operating states of internal combustion engine 1, which differ by the number of cylinders that are activated regarding the charge cycle.

1-9. (canceled)

10. A method for operating an internal combustion engine, the method comprising:
supplying air to the internal combustion engine via an actuator in an air supply, a quantity of air supplied to the internal combustion engine being influenced by a position of the actuator; and
changing a charge cycle state of at least one cylinder of the internal combustion engine, wherein with the change of the charge cycle state of the at least one cylinder the position of the actuator in the air supply is changed, and in an unfired state of the internal combustion engine, changing the position of the actuator in the air supply to one of (i) reduce the quantity of air supplied to the internal combustion engine with an interruption of a previously activated charge cycle over at least one cylinder, and (ii) increase the quantity of air supplied to the internal combustion engine with an activation of a previously interrupted charge cycle over at least one cylinder;
wherein the position of the actuator in the air supply is changed by a predefined value, and the predefined value is determined so that, after the change of the charge cycle state of the at least one cylinder and a simultaneously occurring change in the position of the actuator, a clutch torque remains constant.

11. The method of claim 10, wherein the predefined value is ascertained by at least one of calibration and modeling.

12. The method of claim 10, wherein the charge cycle in one-half of the cylinders is changed.

13. The method of claim 10, wherein the charge cycle over the at least one cylinder is at least one of (i) interrupted by deactivating its valve gear on at least one of the intake side and the exhaust side, and (ii) activated by activating its valve gear on at least one of the intake side and the exhaust side.

14. A device for operating an internal combustion engine, the internal combustion engine including an actuator in an air supply of the internal combustion engine for influencing a quantity of air supplied to the internal combustion engine, comprising:
an arrangement to change a charge cycle state of at least one cylinder of the internal combustion engine;
an actuating arrangement to change a position of the actuator in the air supply with the change of the charge cycle state of the at least one cylinder, the actuating arrangement one of (i) changing the position of the actuator in the air supply to reduce a quantity of air supplied to the internal combustion engine in an unfired state of the internal combustion engine with an interruption of a previously activated charge cycle over at least one cylinder, and (ii) changing the position of the actuator in the air supply to increase the quantity of air supplied to the internal combustion engine with an activation of a previously interrupted charge cycle over at least one cylinder, wherein the actuating arrangement changes the position of the actuator in the air supply by a predefined value; and
a determining arrangement to determine the predefined value so that, after the change of the charge cycle state of the at least one cylinder and a simultaneously occurring change in the position of the actuator, a clutch torque remains constant.

15. The device of claim 14, wherein the predefined value is ascertained by at least one of calibration and modeling.

16. The device of claim 14, wherein the charge cycle in one-half of the cylinders is changed.

17. The device of claim 14, wherein the charge cycle over the at least one cylinder is at least one of (i) interrupted by deactivating its valve gear on at least one of the intake side and the exhaust side, and (ii) activated by activating its valve gear on at least one of the intake side and the exhaust side.

18. The device of claim 14, wherein the charge cycle in every other cylinder of the ignition sequence is changed.

19. The method of claim 10, wherein the charge cycle in every other cylinder of the ignition sequence is changed.
